(19) United States
(12) Patent Application Publication
(10) Pub. No.: US 2005/0086868 A1
(43) Pub. Date: Apr. 28, 2005

(54) Sealing assembly for doors and other closures

(76) Inventor: Albert Santelli JR., Martinsville, NJ (US)

Correspondence Address: DUANE MORRIS LLP, PO BOX 5203, PRINCETON, NJ, 08543-5203, US

(21) Appl. No.: 10/692,077

(22) Filed: Oct. 23, 2003

(51) Int. Cl. E06B 7/22

(52) U.S. Cl. 49/499.1

(57) ABSTRACT

A sealing assembly for sealing a gap between the worn and rounded edge of an overhead door and a floor surface. The sealing assembly has a flexible seal including a first member of a coupling arrangement extending along a length of the seal, an edge cover including a second member of the coupling arrangement extending along a length of the cover, the second member of the coupling arrangement cooperating with the first member of the coupling arrangement to couple the seal and the cover together, and a stop member extending along a length of the cover. The stop member protrudes beyond the coupling arrangement to substantially prevent the coupling arrangement from transmitting a force into the cover when the door is moved to a closed position and the seal engages the floor surface.

### FIELD OF THE INVENTION

The present invention relates to sealing devices for doors and other closures and, more particularly, to a sealing assembly for restricting the passage of air and moisture through a gap between the edge of a door or closure and another surface.

### BACKGROUND OF THE INVENTION

Overhead doors, such as garage or other industrial doors, typically have a bottom edge surface that forms one or more gaps with the floor surface. Strong winds associated with severe weather often drive air, water, and debris through the gap or gaps between the floor surface and the bottom edge surface of the overhead door.

There are many well known methods for restricting the passage of weather through the gap at the bottom of overhead doors. Most of these methods involve using some type of sealing device or seal assembly in the gap between the floor and the bottom edge surface of the overhead door.

FIG. 1 shows one popular type of well known seal assembly 10. This seal assembly 10 includes a spring-like, edge cover 12 that attaches to the bottom edge of the overhead door and a flexible seal 16 that couples to the bottom 14 of the edge cover 12.

The seal assembly 10 of FIG. 1 is typically purchased by door manufacturers who install the seal assemblies to the new overhead doors they manufacture. The seal assembly 10 is also purchased by homeowners and the like who retro-fit the seal assemblies to used overhead doors.

As shown in FIGS. 2A and 2B, one problem with retrofitting the seal assembly of FIG. 1 to a used overhead door is that the bottom edge 20 of the door 18 is typically rounded from years of abuse. This is particularly a problem with overhead doors that are made from wood. The rounded edge is problematic because it allows the lateral portions 22 of edge cover 12 to bend up as shown in FIG. 2B as the seal assembly 10 engages the floor surface 24 when the door 18 is moved to the closed position. Over a relatively short period of time, the lateral portions 22 of the edge cover 12 become fractured thereby causing the seal assembly 10 to fail and detach from the bottom edge 20 of the door 18.

Therefore, a more reliable and improved sealing assembly for worn overhead doors is needed.

### SUMMARY OF THE INVENTION

The present invention is a sealing assembly for sealing a gap between an edge of a closure and a surface. The sealing assembly comprises a seal, an edge cover, a coupling arrangement for coupling the seal and the edge cover together, and a stop member extending along a length of the edge cover. The stop member protrudes beyond the coupling arrangement to substantially prevent the coupling arrangement from transmitting a bending force into the edge cover when the closure is moved to a closed position and the seal engages the surface.

### BRIEF DESCRIPTION OF THE DRAWINGS

FIG. 1 is an end view of a prior art sealing assembly.

FIG. 2A is an end view of the prior art sealing assembly of FIG. 1 installed to a worn and rounded bottom edge of an overhead door.

FIG. 2B is an end view of the prior art sealing assembly and overhead door of FIG. 2A engaging a floor surface.

FIG. 3A is a perspective view of a section of the sealing assembly according to an exemplary embodiment of the present invention.

FIG. 3B is an end view of the sealing assembly of FIG. 3A.

FIG. 4A is a perspective view of an exemplary embodiment of a section of the edge cover of the sealing assembly of the present invention.

FIG. 4B is an end view of the edge cover of FIG. 4A.

FIG. 5A is a perspective view of an exemplary embodiment of a section of the seal of the sealing assembly of the present invention.

FIG. 5B is an end view of the seal of FIG. 5A.

FIG. 6A is an end view of the sealing assembly of the present invention installed to a worn and rounded bottom edge of an overhead door.

FIG. 6B is an end view of the sealing assembly of the present invention and overhead door of FIG. 6A engaging a floor surface.

FIG. 7 is a perspective view of a second exemplary embodiment of a section of the edge cover of the sealing assembly of the present invention.

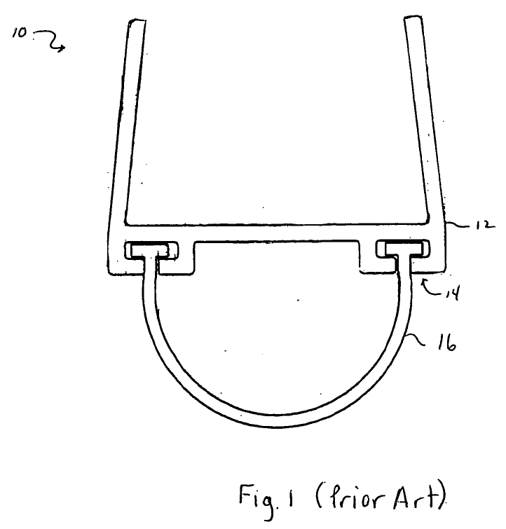

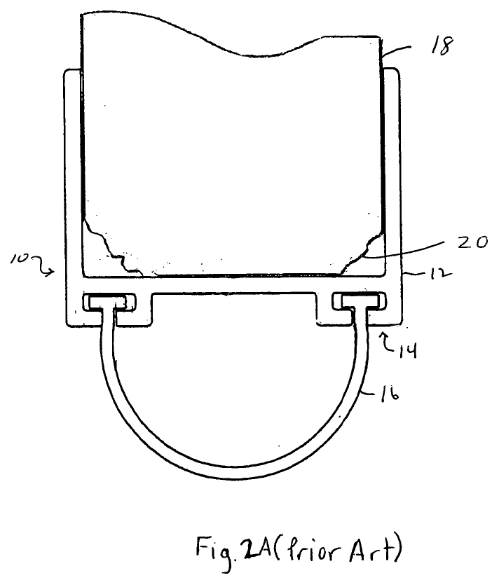

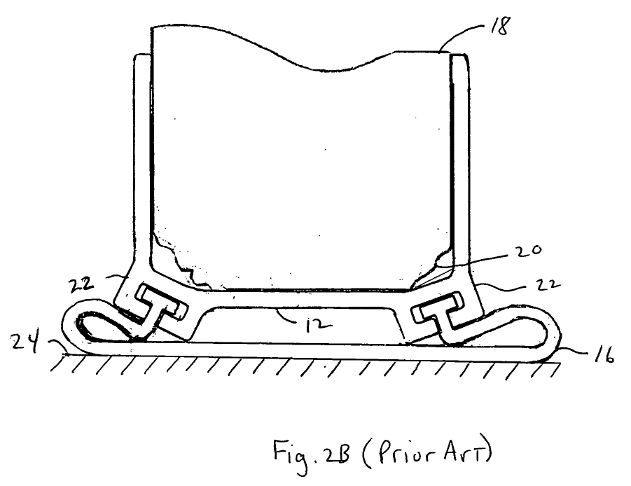

### DETAILED DESCRIPTION

The present invention is a sealing assembly for an overhead door, such as a garage door or other industrial type door, which is mounted to move vertically between open and closed positions wherein in the closed position, the bottom edge of the door rests against the floor surface (absent a sealing assembly). The sealing assembly is especially intended for overhead doors that have worn bottom edges. One of ordinary skill in the art will of course recognize that the sealing assembly of the present invention may also be used with new overhead doors and other types of doors and closures.

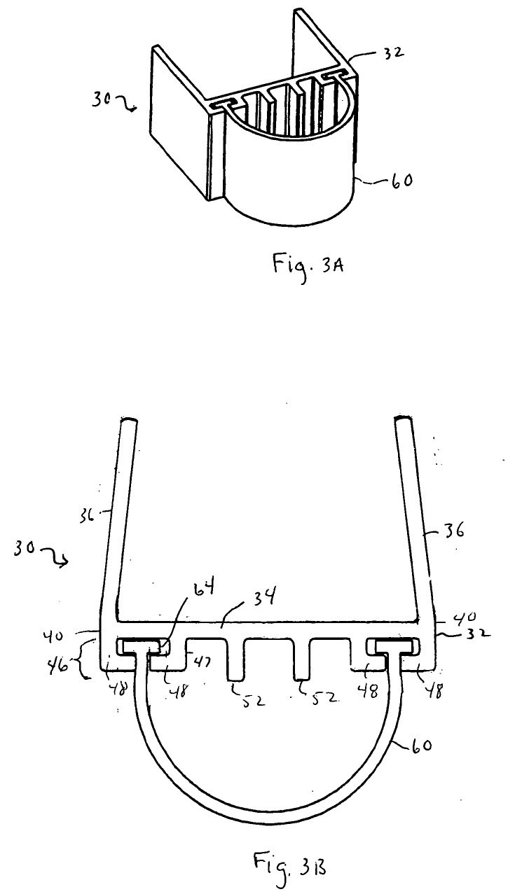

Referring now to the drawings and initially to FIGS. 3A and 3B, there is shown an exemplary embodiment of the sealing assembly 30 of the present invention. The sealing assembly 30 generally comprises an edge cover 32, and a flexible seal 60 coupled to the edge cover 32 to form a compressible, U-shape seal. The sealing assembly 30 may be dimensioned to fit virtually any sized overhead door or other closure.

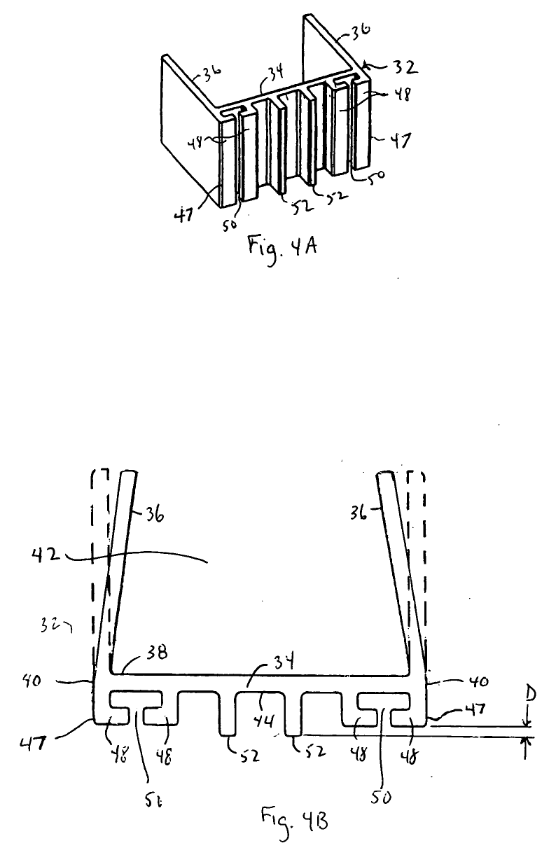

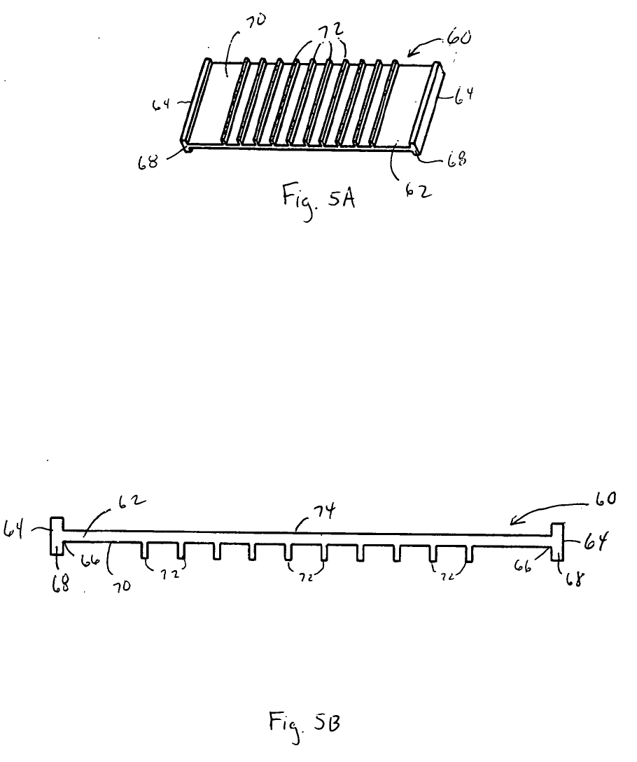

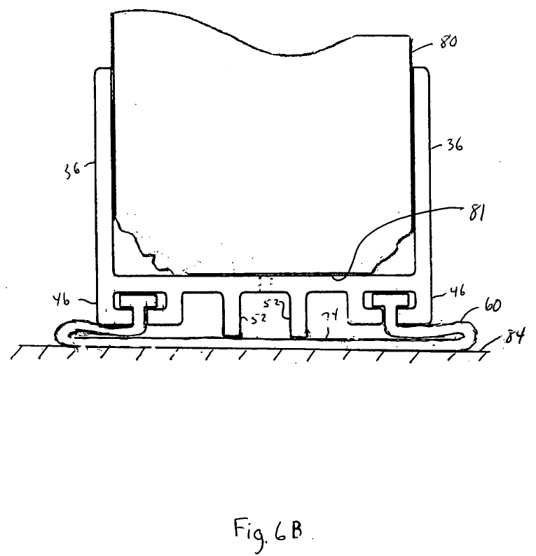

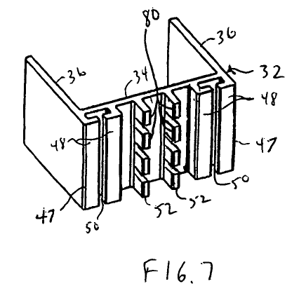

As shown in FIGS. 4A and 4B, the edge cover 32 is formed by a base wall 34 with oppositely disposed, inwardly inclined vertical side walls 36 that extend from the base wall's interior surface 38, adjacent the lateral edges 40 thereof. The base and side walls 34, 36 of the edge cover 32 form an interior cavity 42. The side walls 36 are resilient and thus, can be spread apart so that the edge cover 32 can be placed over a bottom edge 81 of an overhead door 80. Once installed, the side walls 36 clamp the overhead door 80 to retain the edge cover 32 over the bottom edge 81 of the door 80 as shown in FIG. 6A. Fasteners, which extend through the base wall 34 and/or one or both of the side walls 36, may be used in addition to the side walls 36 or in the absence of the side walls 36, to retain the edge cover 32 over the bottom edge 81 of the door 80.

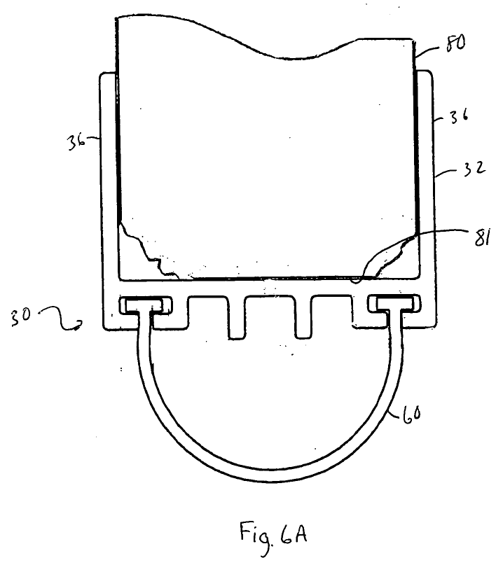

As shown in FIGS. 5A and 5B, the flexible seal 60 may be constructed as a substantially planar web 62. The exterior surface 70 of the web 62 is optionally provided with one or more parallel sealing ribs 72 that extend the entire length of the web 62. The sealing ribs 72 fill small surface imperfections in the floor surface, thus, enhancing the seal between the bottom edge of the door and the floor surface.

Referring to FIG. 3B, the edge cover 32 and the flexible seal 60 are coupled together by a coupling arrangement 46. The coupling arrangement 46 may include one or more coupling members 47 on the edge cover 32 (FIGS. 4A and 4B) and one or more corresponding coupling members 64 on the seal 60 (FIGS. 5A and 5B). In the shown embodiment, the coupling members 47 of the edge cover 32 are disposed along the base wall's exterior surface 44 adjacent the lateral edges 40 thereof. Each edge cover coupling member 47 is formed by a pair of opposing, L-shape flanges 48, which are spaced from one another to define a T-shape groove 50. The corresponding coupling members 64 of the seal 60 are disposed along the lateral edges 66 of the web 62. Each seal coupling member is formed by a vertical flange 68 that snaps into one of the T-shape grooves 50 of the edge cover 32 when the seal 60 is coupled thereto.

Referring again to FIGS. 4A and 4B, the exterior surface 44 of the edge cover base wall 34 further includes one or more stop members 52 that extend the entire length of the base wall 34. The one or more stop 52 members extend further distance D from the exterior surface 44 of the base wall 34 than the coupling arrangement 46, thereby operating as stop as will be explained further on. The stop members may be formed in any suitable geometric configuration. For example, as shown in FIGS. 4A and 4B, each of the stop members 52 may be formed as continuous rectangular flange. In another example, the stop members 52 may be formed as a plurality of rectangular flange segments 80 as shown in FIG. 7.

The edge cover 32 may be made from any suitable, weather resistant material having spring-like properties, using any suitable forming process. In a preferred embodiment, the edge cover 32 may be formed by extrusion, from a PVC material. The seal 60 is made from any suitable, weather resistant flexible material, which is capable of maintaining its flexibility near or at sub zero temperatures. In a preferred embodiment, the seal 60 is extruded from urethane.

FIG. 6A shows the sealing assembly 30 installed over the worn and rounded bottom edge 81 of an overhead door 80. As shown in FIG. 6B, as the door 80 is moved toward a closed position, the flexible seal 60 contacts the floor surface 84 and start to compress. As the bottom edge 81 of the door 80 moves closer to the floor surface 84, the stop flanges 52 contact the interior surface 74 of the seal web 62 to prevent further compression of the seal 60 and downward movement of the door 80. Thus, the coupling arrangement 46 is prevented from bottoming out on the web 62 of the seal 60 and forcing the unsupported lateral portions of the edge cover 32 to bend up against the worn bottom edge 81 of the door 80. Since the base wall 34 of the edge cover 32 is not repeatedly bent upward, the edge cover is much less likely to fracture over time as with prior art sealing assemblies.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A sealing assembly for sealing a gap between an edge of a closure and a surface, the sealing assembly comprising:
an edge cover;
a flexible seal;
a coupling arrangement for coupling the seal and the cover together; and
a stop member extending along a length of the cover, the stop member protruding beyond the coupling arrangement to substantially prevent the coupling arrangement from transmitting a force into the cover when the closure is moved to a closed position and the seal engages the surface.

2. The sealing assembly of claim 1, wherein the stop member comprises a continuous flange.

3. The sealing assembly of claim 1, wherein the stop member comprises a segmented flange.

4. The sealing assembly of claim 1, wherein the stop member comprises two continuous flanges.

5. The sealing assembly of claim 1, wherein the stop member comprises two segmented flanges.

6. The sealing assembly of claim 1, wherein the closure comprises an overhead door and the surface comprises a floor surface.

7. A sealing assembly for sealing a gap between an edge of a closure and a surface, the sealing assembly comprising:
a flexible seal including a first member of a coupling arrangement extending along a length of the seal;
an edge cover including a second member of the coupling arrangement extending along a length of the cover, the second member of the coupling arrangement cooperating with the first member of the coupling arrangement to couple the seal and the cover together; and
a stop member extending along a length of the cover, the stop member protruding beyond the coupling arrangement to substantially prevent the coupling arrangement from transmitting a force into the cover when the closure is moved to a closed position and the seal engages the surface.

8. The sealing assembly of claim 7, wherein the stop member comprises a continuous flange.

9. The sealing assembly of claim 7, wherein the stop member comprises a segmented flange.

10. The sealing assembly of claim 7, wherein the stop member comprises two continuous flanges.

11. The sealing assembly of claim 7, wherein the stop member comprises two segmented flanges.

12. The sealing assembly of claim 7, further comprising retaining means for retaining the cover over the edge of the closure.

13. The sealing assembly of claim 12, wherein the retaining means includes a pair of side walls extending from the cover, the side walls operating to clamp the closure to retain the cover over the edge of the closure.

14. The sealing assembly of claim 7, wherein the closure comprises an overhead door and the surface comprises a floor surface.

15. A closure comprising:
an edge;
a sealing assembly for sealing a gap between the edge of the closure and a surface, the sealing assembly including:
a flexible seal including a first member of a coupling arrangement extending along a length of the seal;
an edge cover disposed over the edge of the closure, the edge cover including a second member of the coupling arrangement extending along a length of the cover, the second member of the coupling arrangement cooperating with the first member of the coupling arrangement to couple the seal and the cover together; and
a stop member extending along a length of the cover, the stop member protruding beyond the coupling arrangement to substantially prevent the coupling arrangement from transmitting a force into the cover when the closure is moved to a closed position and the seal engages the surface.

16. The closure of claim 15, wherein the closure comprise an overhead door and the surface comprises a floor surface.

17. The closure of claim 16, wherein the edge of the overhead door is rounded.

18. The closure of claim 15, wherein the stop member comprises a continuous flange.

19. The closure of claim 15, wherein the stop member comprises a segmented flange.

20. The closure of claim 15, wherein the stop member comprises two continuous flanges.

21. The closure of claim 15, wherein the stop member comprises two segmented flanges.
